(19) United States
(12) Patent Application Publication
(10) Pub. No.: US 2026/0323336 A1
(43) Pub. Date: Oct. 15, 2026

(54) COMMUNICATION MEASUREMENT CONFIGURATION METHOD, DEVICE AND STORAGE MEDIUM

(71) Applicant: CHINA SATELLITE NETWORK INNOVATION CO., LTD, Beijing (CN)

(72) Inventors: Dongqing QI, Beijing (CN); Dianting Chi, Beijing (CN); Ge Mang, Beijing (CN); Yang Zhang, Beijing (CN)

(21) Appl. No.: 19/696,079

(22) Filed: Jun. 2, 2026

Related U.S. Application Data
(63) Continuation of application No. PCT/CN2025/128310, filed on Oct. 17, 2025.

(30) Foreign Application Priority Data
Jan. 26, 2025 (CN) 202510125461.X

(51) Int. Cl. H04W 24/08

(52) U.S. Cl. CPC H04W 24/08

(57) ABSTRACT

The present disclosure relates to the field of communication technologies, and particularly to a communication measurement configuration method, a device and a storage medium. The method on a base station side includes: configuring corresponding measurement configuration information specific to a beam for SSB transmission; and broadcasting the configured measurement configuration information to a coverage area corresponding to the beam for SSB transmission. According to the embodiments of the present disclosure, a cell can be divided into the granularity of beam positions, where the coverage area corresponding to one beam for SSB transmission corresponds to one beam position, and different measurement configuration information is configured for different beams for SSB transmission. Therefore, a terminal (e.g., a satellite terminal) located in the corresponding beam position is enabled to perform measurement only based on the measurement configuration information specific to the beam position, so as to reduce the power consumption of the terminal.

### CROSS REFERENCE TO RELATED APPLICATION

The present application is a continuation of International Patent Application No. PCT/CN 2025/128310, filed on Oct. 17, 2025, which claims the priority of Chinese Patent Application No. 202510125461.X, entitled “Communication measurement configuration method, device and storage medium” and filed on Jan. 26, 2025, both of which are incorporated herein by reference in their entireties.

### TECHNICAL FIELD

The present disclosure relates to the field of communication technologies, and particularly to a communication measurement configuration method, a device and a storage medium.

### BACKGROUND

In a 5G mobile communication system, to ensure the service continuity of a terminal during movement, while detecting the signal strength of a serving cell, the terminal needs to perform signal strength measurements on neighboring cell beams, with the measurement target being a reference signal SSB (SS/PBCH Block, Synchronization Signal and Physical Broadcast Channel Block). The SSB is carried on a specific beam after beamforming, and a cell can have a plurality of SSBs. A plurality of time-domain adjacent SSBs form an SSB burst set, in which each SSB corresponds to a unique index (SSB Index). The time-domain positions of the SSBs with different indexes are fixed and transmitted sequentially by means of beam scanning, so as to achieve coverage of the synchronization signals across the entire cell area. 3GPP constrains the validity scope of system information to be a cell level at minimum, meaning that the content of the system information broadcast within a cell must be identical. When downlink coverage enhancement is achieved by extending an SSB period, in most of the measurement windows the terminal monitors, through a receiver, SSBs of neighboring cells completely undetectable, which seriously impacts the standby power consumption of the terminal.

### SUMMARY

An object of the embodiments of the present disclosure is to provide a communication measurement configuration method, a device and a storage medium, so as to solve the problem of relatively high energy consumption in the measurement by a terminal in the prior art.

To achieve the above objective, in an aspect, the embodiments of the present disclosure provide a communication measurement configuration method, wherein the method is performed by a base station side, and includes:
configuring corresponding measurement configuration information specific to a beam for synchronization signal and physical broadcast channel block (SSB) transmission;
broadcasting the configured measurement configuration information to a coverage area corresponding to the beam for SSB transmission.

In another aspect, the embodiments of the present disclosure further provide a communication measurement configuration method, wherein the method is performed by a terminal side, and includes:
identifying whether a beam for SSB transmission selected by a terminal has changed;
if the beam for SSB transmission selected by the terminal has changed, receiving system information and obtaining measurement configuration information specific to the beam for SSB transmission selected by the terminal.

In another aspect, the embodiments of the present disclosure further provide a base station, including:
at least one processor; and
at least one memory storing instructions thereon, wherein when executed individually or collectively by the at least one processor, the instructions cause the base station to perform the afore-mentioned communication measurement configuration method on the base station side.

In another aspect, the embodiments of the present disclosure further provide a terminal, including:
at least one processor; and
at least one memory storing instructions thereon, wherein when executed individually or collectively by the at least one processor, the instructions cause the terminal to perform the afore-mentioned communication measurement configuration method on the terminal side.

In another aspect, the embodiments of the present disclosure further provide a computer storage medium storing a computer program thereon, wherein when executed by a processor of a computer device, the computer program executes instructions of the afore-MENTIONED methods.

In another aspect, the embodiments of the present disclosure further provide a computer program product including a computer program, wherein when executed by a processor of a computer device, the computer program executes instructions of the afore-mentioned methods.

As can be seen from the technical solutions provided by the embodiments of the present disclosure, by broadcasting the measurement configuration information specific to the beam for SSB transmission corresponding to each beam position (i.e., the coverage area of the beam for SSB transmission), the embodiments of the present disclosure can divide a cell into the granularity of beam positions. The coverage area corresponding to one beam for SSB transmission corresponds to one beam position, and different measurement configuration information is configured for different beams for SSB transmission. Therefore, a terminal (e.g., a satellite terminal) located in the corresponding beam position can be enabled to perform measurement only based on the measurement configuration information specific to the beam position, so as to reduce the energy consumption of the terminal.

### BRIEF DESCRIPTION OF DRAWINGS

To illustrate the technical solutions in the embodiments of the present disclosure or in the prior art more clearly, a brief description of the drawings required for describing the embodiments or the prior art is provided below.

FIG. 1 illustrates a schematic diagram of a neighboring cell detection window in a downlink coverage enhancement scenario;

FIG. 2 illustrates a flowchart of a communication measurement configuration method according to an embodiment of the present disclosure;

FIG. 3a illustrates a schematic diagram of neighboring area detection according to an embodiment of the present disclosure;

FIG. 3b illustrates a schematic diagram of a measurement window configured for a beam position A according to an embodiment of the present disclosure;

FIG. 4 illustrates a schematic diagram of the changes of cells adjacent to a beam position according to an embodiment of the present disclosure;

FIG. 5 illustrates a schematic diagram of the exchange of neighboring cell configuration information between base stations according to an embodiment of the present disclosure;

FIG. 6 illustrates a flowchart of a communication measurement configuration method according to an embodiment of the present disclosure;

FIG. 7 illustrates a schematic diagram of an overall measurement configuration process according to an embodiment of the present disclosure;

FIG. 8 illustrates a schematic diagram of a terminal according to an embodiment of the present disclosure; and

FIG. 9 illustrates a schematic diagram of the architecture of a network device according to an embodiment of the present disclosure.

### DETAILED DESCRIPTION

To enable those skilled in the art to better understand the technical solutions in the present disclosure, the technical solutions in the embodiments of the present disclosure will be described clearly and completely below with reference to the drawings for the embodiments of the present disclosure. Apparently, those described are merely part, rather than all, of the embodiments of the present disclosure. Based on the embodiments of the present disclosure, all other embodiments obtained by those of ordinary skill in the art without creative efforts shall fall within the protection scope of the present disclosure.

In the description of the present disclosure, unless otherwise specified, “and/or” describes an association relationship between associated objects and indicates that three relationships may exist. For example, A and/or B may indicate the three cases: A exists alone, both A and B exist simultaneously, and B exists alone, where A and B may be singular or plural. In addition, in the description of the present disclosure, unless otherwise specified, “a plurality of” refers to two or more. “At least one of . . . ” or a similar expression refers to any combination of the listed items, including any combination of a single item or a plurality of items. For example, “at least one of a, b, or c” may indicate “a”, “b”, “c”, “a and b”, “a and c”, “b and c”, or “a, b and c”, where each of a, b and c may be singular or plural.

In the present disclosure, the expressions “greater than” or “less than” may be used to determine whether a specific condition is satisfied, but this is merely provided as an example and are not intended to exclude the expressions of “greater than or equal to” or “less than or equal to”. A condition described as “greater than or equal to” may be replaced with “greater than”; a condition described as “less than or equal to” may be replaced with “less than”; and a condition described as “greater than or equal to . . . and less than” may be replaced with “greater than . . . and less than or equal to”. In addition, hereinafter, “A to B” means at least one of the elements from A (inclusive) to B (inclusive).

In the embodiments of the present disclosure, a singular form such as “a/an” and “the” includes a plural form, and shall be understood in a broad sense as “one kind of” or “one type of” rather than being limited to the meaning of “one single”. In addition, the term “said” shall be understood as including both the singular and plural forms unless the context clearly indicates otherwise. Furthermore, the term “according to” shall be understood as “at least in part according to . . . ”, and the term “based on” shall be understood as “at least in part based on . . . ” unless the context clearly indicates otherwise.

The specification provides the operation steps of the method as illustrated in the embodiments or the flowcharts, but more or fewer operation steps may be included based on conventional or non-creative efforts. The order of the steps listed in the embodiments is merely one of the numerous possible execution orders and does not represent the sole one. In actual implementation by a system or an apparatus product, the steps may be executed in sequence or in parallel in accordance with the method in the embodiments or shown in the drawings.

To be noted, in the embodiments of the present disclosure, reference may be made to certain existing industry solutions such as software, components and models. These solutions shall be regarded as exemplary, for the only purpose of demonstrating the feasibility of implementing the technical solutions of the present disclosure, but does not mean that the applicant has adopted or necessarily will adopt such solutions.

The present disclosure uses the terms employed in some communication specifications (e.g., the 3rd Generation Partnership Project (3GPP), European Telecommunications Standards Institute (ETSI), Extensible Radio Access Network (ERAN), Open Radio Access Network (O-RAN)) to illustrate various embodiments, which is merely for illustrative purposes. Various embodiments of the present disclosure can also be easily modified and applied in other communication systems.

In the embodiments of the present disclosure, the communications between devices in a communication system may be performed in accordance with communication protocols at any stage, including but not limited to the following communication protocols: 1G (generation), 2G, 2.5G, 2.75G, 3G, 4G, 4.5G and 5G, New Radio (NR), etc., and/or other currently known or future-developed communication protocols.

To facilitate understanding, the technical terms involved in the embodiments of the present disclosure are explained below.

(1) Terminal device: refers to a device that has a wireless transceiving function and can cooperate with a network device to provide communication services for users. The terminal device may also be referred to as a terminal, User Equipment (UE), a user terminal, a Mobile Terminal (MT), a user agent, or the like. For example, the terminal device may be a mobile phone, a tablet computer, a notebook computer, a wearable device, a Virtual Reality (VR) device, an Augmented Reality (AR) device, a wireless communication device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, an Internet of Things (IoT) device, a Narrowband Internet of Things (NB-IoT) device, a Vehicle-to-Everything (V2X) device, a device in Device-to-Device Communication (D2D), an Enhanced Machine Type Communication (eMTC) device, a Reduced Capability (RedCap) device, a cellular phone, a cordless phone, a Session Initiation Protocol (SIP) phone, a Wireless Local Loop (WLL) station, a Personal Digital Assistant (PDA), a client, a handheld device with a wireless communication function, a vehicle-mounted device, a ship-borne device, etc.

In scenarios such as the Internet of Things (IoT), the terminal device may also be a machine or apparatus for monitoring or measurement, including but not limited to, for example: a Machine Type Communication (MTC) terminal, a vehicle-mounted communication terminal, a Device to Device (D2D) terminal, a Machine to Machine (M2M) terminal, etc.

(2) Network device: refers to a network-side device capable of communicating with the terminal device. The network device may be located on a satellite or on the ground. The network device may also be referred to as a space base station, a satellite-borne base station, a satellite, a satellite communication node, a satellite network terminal device, a satellite communication module, or a base station, etc. The network-side device may also be referred to as an access network device or a radio access network device. The network-side device may be a Base Transceiver Station (BTS) in a Global System for Mobile Communication (GSM) or a Code Division Multiple Access (CDMA) communication system carried by a satellite; a NodeB (NB) in a Wideband Code Division Multiple Access (WCDMA) system carried by a satellite; an evolved NodeB (eNB or eNodeB) in an LTE system carried by a satellite; a base station in a terrestrial network or a Non-Terrestrial Network (NTN), such as a base station (gNB) in a 5G network carried by a satellite; a base station in a future network (e.g., a 6G network) after the 5G network carried by a satellite; a base station in a future-evolved Public Land Mobile Network (PLMN) carried by a satellite; a Transmission Reception Point (TRP) carried by a satellite; a radio controller in the scenario of a Cloud Radio Access Network (CRAN) carried by a satellite; or an urban base station, a micro base station, a pico base station or a femto base station carried by a satellite, etc. The base station may also be a terrestrial base station capable of communicating with a satellite, and may be referred to as an Access Point (AP), a 5th generation (5G) node, a wireless point, a Transmission/Reception Point (TRP), or other terms with an equivalent technical meaning. The network device may also be a base station device carried by a High Altitude Platform Station (HAPS) with a loitering capability such as a large balloon or an airship; a base station device in a Roadside Unit (RSU); or a base station device in the Vehicle-to-Everything (V2X), etc.

Both the terminal device and the base station device may perform beamforming, but the embodiments of the present disclosure are not limited thereto. In some embodiments, the terminal may or may not perform beamforming. Likewise, the base station may or may not perform beamforming. That is, only one of the terminal and the base station may perform beamforming, or neither the terminal nor the base station may perform beamforming. In the present disclosure, a beam refers to the spatial propagation of a signal in a wireless channel, which is formed by one or more antennas or antenna elements, and this formation process may be referred to as beamforming.

In addition, the term “network side” or “network device side” refers to the side of the network, which may be a certain base station, or may include one or more network devices as mentioned above. The term “terminal side” or “terminal device side” refers to the side of the user or terminal, which may be a certain UE, or may include one or more terminal devices as mentioned above.

Due to the limited number of satellites and the limited number of satellite antennas, a typical solution to achieve the wide-area coverage is to extend a default SSB period (ssb-periodicityServingCell), thus enabling a single antenna to cover more ground areas in a time-division manner, and 3GPP has conducted special researches thereon in the downlink coverage enhancement project of Release 19.

In a terrestrial 5G communication scenario, the SSB period is relatively short. Taking SSB pattern case C as an example, the SSB period is 20 ms, with 8 SSBs (SSB indexes 0 to 7) concentrated in the first 2 ms of each 20 ms dual frame, and each cell can provide synchronization signals and access services for 8 beam positions within 20 ms.

In a downlink coverage enhancement scenario of satellite communication, the SSB period needs to be increased. Taking the scenario where the SSB period is increased to 160 ms as an example, from the perspective of a single terminal, an SSB appears once every 160 ms. From the perspective of a base station, it still transmits 8 SSBs every 20 ms; however, within a period of 160 ms, the 64 SSBs transmitted by the base station are used to serve 64 different beam positions (in contrast, the SSB period of 20 ms can only serve 8 beam positions). In this way, the base station can serve more beam positions by extending the SSB period for a single terminal, thereby achieving downlink coverage enhancement.

The method of increasing the SSB period and expanding the number of served beam positions within the period as described above can effectively increase the coverage area of the satellite, but it will exert a severe negative impact on the configuration of a measurement window. Still taking the afore-mentioned scenario as an example, a single beam for SSB transmission may expand the coverage to 64 beam positions within an SSB period of 160 ms. When a terminal needs to perform neighboring cell measurement, the number of time-domain positions where the SSBs of the neighboring cell may appear also increases from 8 (these 8 SSBs are concentrated in the first 2 ms of every 20 ms, i.e., concentrated in one SSB burst set) to 64, and distributed across 8 SSB burst sets (also referred to as SSB measurement time windows). It is impossible to clearly indicate to the terminal the time-domain positions to be measured, which results in the terminal having to perform blind detection within 8 measurement time windows where SSBs may exist (the configuration granularity of SMTC is 1 ms, and a conventional configuration is that each SSB burst set corresponds to one measurement time window). However, in most scenarios, the SSBs may only exist in one window. On one hand, this wastes the power consumption of the terminal; on the other hand, it also increases the rates of false detection and missed detection of the SSBs by the terminal since the SSBs are absent in most of the configured windows.

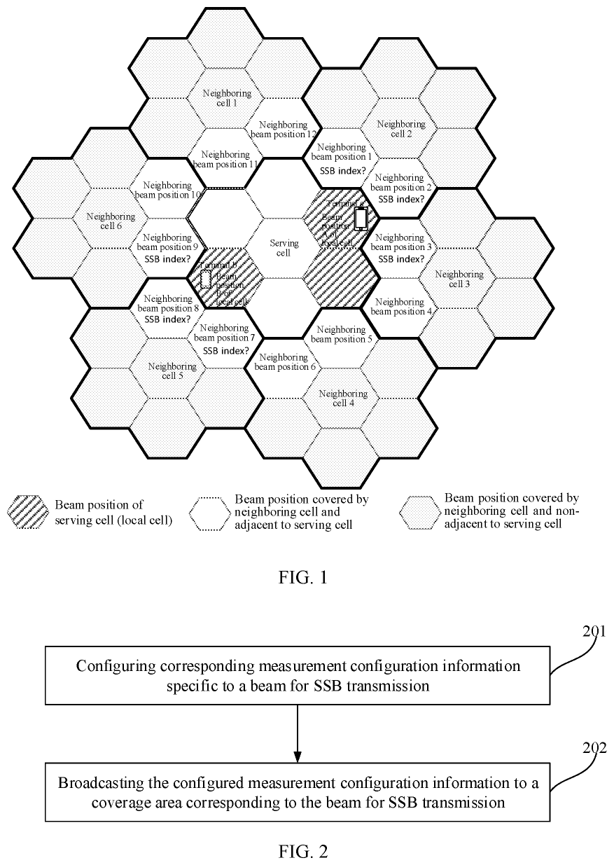

As illustrated in FIG. 1, it is a schematic diagram of a neighboring cell detection window in a downlink coverage enhancement scenario. FIG. 1 depicts a cell divided into a plurality of different coverage areas (hereinafter referred to as “beam positions”) corresponding to beams for SSB transmission, wherein each hexagon in FIG. 1 represents a coverage area (beam position) corresponding to one beam for SSB transmission. In other embodiments, the beam position may have other shapes, which is not limited here. The beams for SSB transmission corresponding to different beam positions have different SSB time-domain positions, and the beam for SSB transmission corresponding to each beam position in a cell has a different SSB index. The SSB time-domain position of the beam for SSB transmission indicates a measurement time window and includes a plurality of parameters for measurement, such as those related to the SSB time-domain position, including parameters such as, SMTC, ssb-ToMeasure (used to configure an SSB pattern), and ss-RSSI-Measurement (used to configure a received signal strength indication based on a synchronization reference signal). In FIG. 1, the cells can be classified into a serving cell (i.e., a local cell) and adjacent cells (i.e., the cells around the serving cell, also called neighboring cells). The adjacent cells include neighboring beam positions adjacent to the serving cell, and beam positions non-adjacent to the serving cell. In the prior art, the aforementioned measurement parameters are carried in system information (SIBs), and the broadcasting mode of system information is cell-specific. Thus, only the measurement windows for all the beam positions of all 6 neighboring cells around the serving cell can be configured for the terminal. As a result, only about a quarter of the measurement windows are effective when the terminal measures the adjacent cells. In most of the measurement windows, the terminal will futilely activate the receiver to monitor the SSBs of the neighboring cells completely undetectable, which severely affects the standby power consumption of the terminal. The embodiments of the present disclosure are directed to a simple scenario where a single cell covers 7 beam positions. In practical scenarios, a single cell may cover a greater number of beam positions. The more beam positions there are, the more edge beam positions will be present, and the more severe the above problem will become. In the embodiments of the present disclosure, a terminal a as illustrated in FIG. 1 is located within a coverage area A (i.e., in a beam position A) corresponding to the beam for SSB transmission, the cells adjacent thereto are a neighboring cell 2 and a neighboring cell 3 respectively, and the adjacent beam positions in the neighboring cells are a neighboring beam position 1, a neighboring beam position 2 and a neighboring beam position 3. When performing neighboring cell measurement, it is only necessary for the terminal a to measure the SSBs of the beams corresponding to all the beam positions in two neighboring cells (i.e., the neighboring cell 2 and the neighboring cell 3), or measure the SSBs of the beams corresponding to three adjacent neighboring beam positions in the two neighboring cells. Similarly, the terminal b only needs to measure the SSBs of the beams corresponding to all the beam positions in two neighboring cells (i.e., a neighboring cell 5 and a neighboring cell 6), or measure the SSBs of the beams corresponding to three adjacent neighboring beam positions (i.e., a neighboring beam position 7, a neighboring beam position 8 and a neighboring beam position 9) in the two neighboring cells. That is, for different beams for SSB transmission, the corresponding measurement configuration information is configured in a targeted manner, thereby significantly reducing the measurement workload of the terminal, and saving the energy consumption thereof.

As illustrated in FIG. 2, it is a flowchart of a communication measurement configuration method according to an embodiment of the present disclosure. FIG. 2 depicts a measurement configuration method performed by a base station side. In a satellite communication system, the method according to this embodiment may be performed by a satellite-borne base station, which specifically includes:
Step 201: configuring corresponding measurement configuration information specific to a beam for SSB transmission;
Step 202: broadcasting the configured measurement configuration information to a coverage area corresponding to the beam for SSB transmission.

By broadcasting the measurement configuration information specific to the beam for SSB transmission corresponding to each beam position (i.e., the coverage area of the beam for SSB transmission), the embodiments of the present disclosure can divide a cell into the granularity of beam positions. The coverage area corresponding to one beam for SSB transmission corresponds to one beam position, and different measurement configuration information is configured for different beams for SSB transmission. Therefore, a terminal (e.g., a satellite terminal) located in the corresponding beam position can be enabled to perform measurement only based on the measurement configuration information specific to the beam position, so as to reduce the energy consumption of the terminal.

In some embodiments, the measurement configuration information includes: time-domain positions of SSBs of cells adjacent to the coverage area corresponding to the beam for SSB transmission; and time-domain positions of SSBs of a serving cell to which the coverage area corresponding to the beam for SSB transmission belongs.

In this embodiment, the measurement configuration information corresponding to the coverage area (i.e., the beam position) of each beam for SSB transmission may be broadcast to the beam position by a system information block 2 (SIB2) or a system information block 4 (SIB4), or broadcast within the beam position in other ways.

Further, the measurement configuration information for the terminal to perform cell measurement may also be carried through SMTC, ssb-ToMeasure, ss-RSSI-Measurement, etc. in SIB2 and SIB4.

The measurement configuration information may include: time-domain positions of SSBs corresponding to all beam positions in cells adjacent to the beam position, and time-domain positions of SSBs corresponding to all beam positions in the serving cell to which the beam position belongs. Alternatively, the measurement configuration information may include: time-domain positions of SSBs corresponding to adjacent beam positions in cells adjacent to the beam position, and time-domain positions of SSBs corresponding to the adjacent beam position in the serving cell to which the beam position belongs.

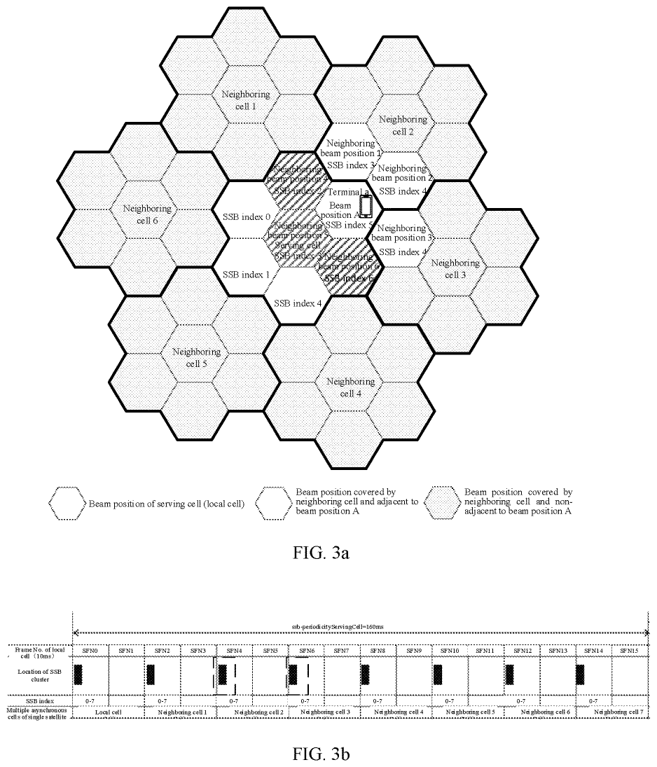

As an embodiment, reference may be made to FIG. 3a, which illustrates a schematic diagram of neighboring area detection according to an embodiment of the present disclosure. In FIG. 3a, the time-domain positions of the SSBs corresponding to the neighboring beam position 1, the neighboring beam position 2 and the neighboring beam position 3 of the cells adjacent to the beam position A in the serving cell may be configured into the measurement configuration information corresponding to the beam position A, for the measurement by the terminal a in the beam position A. In this embodiment, the time-domain positions of the SSBs corresponding to the neighboring beam position 4, the neighboring beam position 5 and the neighboring beam position 6, which are included in the beam positions adjacent to the beam position A in the serving cell, are configured into the measurement configuration information corresponding to the beam position A. Thus, the terminal a in the beam position A can measure the time-domain positions of the SSBs corresponding to the neighboring cell 2 and the neighboring cell 3 as well as the time-domain position of the SSB of the serving cell.

With continued reference to FIG. 3a, regarding the beam position A, the neighboring cell measurement window broadcast by the base station to the beam position A only includes the “beam position-level measurement configuration” of the beam position A, i.e., the time-domain positions of the SSBs of the beams corresponding to the neighboring beam position 1, the neighboring beam position 2, the neighboring beam position 3, the neighboring beam position 4, the neighboring beam position 5 and the neighboring beam position 6 which are adjacent to the beam position A, wherein the neighboring beam position 1 and the neighboring beam position 2 belong to the same adjacent cell 2, and the neighboring beam position 3 belongs to another adjacent cell 3.Both the adjacent cell 2 (neighboring cell 2) and the adjacent cell 3 (neighboring cell 3) have an adjacency relationship or an overlapping coverage relationship with the beam position A. In which, the time-domain positions of the SSBs for different beam positions may be indicated by SSB indexes. The time-domain positions of the SSBs corresponding to the neighboring beam position 1 and the neighboring beam position 2 of the neighboring cell 2 are an SSB index 3 and an SSB index 4 respectively, and the time-domain position of the SSB corresponding to the neighboring beam position 3 of the neighboring cell 3 is an SSB index 4. Reference is made to FIG. 3b, it illustrates a schematic diagram of a measurement window configured for a beam position A according to an embodiment of the present disclosure. Combining FIG. 3a and FIG. 3b, the SSB indexes corresponding to the neighboring beam position 1, the neighboring beam position 2 and the neighboring beam position 3 are SSB index 3, SSB index 4 and SSB index 4, respectively. Measurement is only required in two measurement windows, namely, a system frame number 4 (SFN4) and a system frame number 6(SFN 6 ), i.e., the two measurement windows within the dashed boxes in FIG. 3b, and the corresponding SSB index range of the measurement windows is SSB index 0 to SSB index 7 for each cell. The terminal can clearly understand that, among all 8 measurement windows within a period of 160 ms, it only needs to perform measurements in 2 of them to complete the neighbor cell measurements.

In an embodiment, the time-domain positions of the SSBs of the beams corresponding to all the beam positions in the cells adjacent to the beam position A are configured in the measurement configuration information, i.e., the time-domain positions of the SSBs corresponding to all the beam positions in the adjacent cell 2 (neighboring cell 2) as illustrated in FIG. 3a, as well as the time-domain positions of the SSBs corresponding to all the beam positions in the adjacent cell 3 (neighboring cell 3). In addition, the time-domain positions of the SSBs corresponding to all the beam positions in the serving cell are configured in the measurement configuration information. The computation load of the terminal is far lower than the energy consumption required for measuring all the beam positions in the serving cell and in all the cells adjacent to the serving cell in the prior art. With the embodiment of the present disclosure, the idle-mode measurement power consumption of the terminal located in the beam position A can be reduced by 62.5%.

In another embodiment, only the time-domain positions of the SSBs corresponding to the neighboring beam position 1 and the neighboring beam position 2 in the cell 2 (neighboring cell 2) adjacent to the beam position A, and the time-domain position of the SSB corresponding to the neighboring beam position 3 in the adjacent cell 3 (neighboring cell 3) adjacent to the beam position A are configured in the measurement configuration information. In addition, the neighboring beam position 4 (SSB index 2), the neighboring beam position 5 (SSB index 3) and the neighboring beam position 6 (SSB index 6) which are adjacent to the beam position A in the serving cell are configured therein. In this case, the terminal only needs to measure the time-domain positions corresponding to the SSB index 3 and the SSB index 4 for the neighboring beam position 1 and the neighboring beam position 2 in the neighboring cell 2, the time-domain position corresponding to the SSB index 4 of the neighboring beam position 3 in the neighboring cell 3, and the time-domain positions corresponding to the SSB index 2, the SSB index 3, the SSB index 5 and the SSB index 6 in the serving cell. Therefore, the computation load and the power consumption of the terminal are further reduced.

As an embodiment, the cells adjacent to the coverage area corresponding to the beam for SSB transmission include all cells adjacent to the coverage area corresponding to the beam for SSB transmission during a satellite overpass period of the serving cell.

In the embodiments of the present disclosure, there are three beam coverage schemes in a satellite communication system. The first scheme is a ground-fixed mode, where the beam always continuously covers the same geographic area. The second scheme is a quasi-ground-fixed mode, where the beam covers one geographic area during a limited time period and another geographic area during another time period. The third scheme is a ground-mobile mode, where the coverage area of the beam slides over the ground surface. The solutions of the embodiments of the present disclosure are applicable to the three beam coverage schemes, and whenever the beam for SSB transmission corresponding to the beam position where the terminal is located changes, new measurement configuration information will be obtained for performing measurement. The adjacent cells in the measurement configuration information broadcast by the satellite-borne base station to a certain beam position include all cells that establish an adjacency relationship with the beam position in the serving cell during the satellite overpass period of the serving cell.

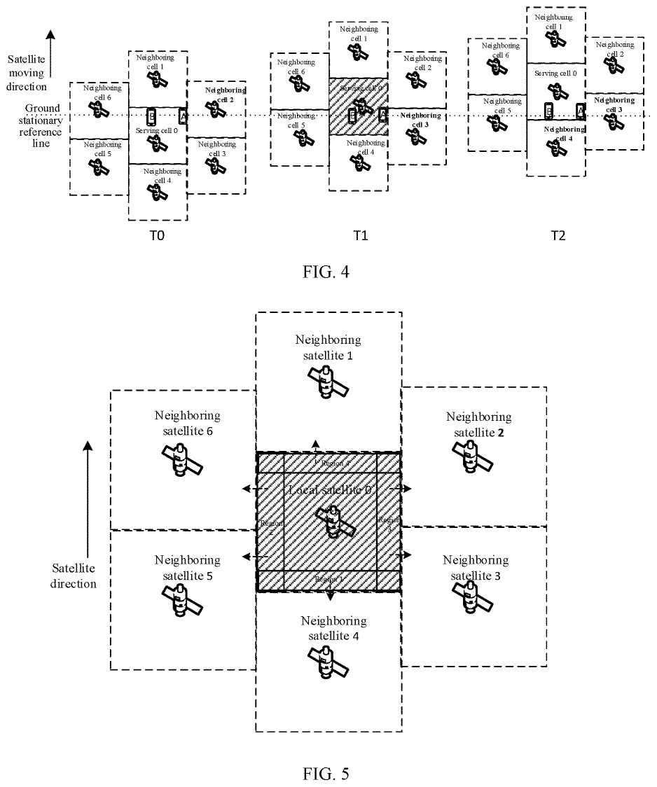

As illustrated in FIG. 4, it is a schematic diagram of the changes of cells adjacent to a beam position according to an embodiment of the present disclosure. FIG. 4 depicts a process where, as the satellite moves, all cells move accordingly, and the cells adjacent to a beam position change continuously, which specifically includes:

At time T0, a terminal A enters the coverage range of a serving cell 0 of a satellite, wherein the serving cell 0 includes multiple beam positions corresponding to beams for SSB transmission, and the terminal A is located in a beam position 1. In this case, the adjacent cell of the beam position 1 where the terminal is located is a neighboring cell 2. In other embodiments, the adjacent cells of the beam position 1 may also include other neighboring cells, which will not be elaborated herein.

As the satellite moves, at the time T1, the terminal A remains in the beam position 1, but all cells move upward. The terminal A is still within the coverage range of the serving cell 0 (service area 0), but the cell adjacent to the beam position 1 has changed to a neighboring cell 3.

As the satellite continues to move, at time T2, the terminal A remains in the beam position 1, and all cells continue to move upward. The terminal A is about to move out of the current serving cell 0 (service area 0). In this case, the cells adjacent to the beam position 1 where the terminal A is located become the neighboring cell 3 and a neighboring cell 4.

In summary, at the time T0, the base station broadcasts system information to the beam position 1 where the terminal A is located through the beam for SSB transmission. The cells adjacent to the beam position 1 in the broadcast system information include the neighboring cell 2, the neighboring cell 3 and the neighboring cell 4.

For the three beam coverage schemes, each scenario is similar to that of the afore-mentioned embodiment, except that the beam for SSB transmission selected by the terminal A may change multiple times, and each time a change occurs, the terminal will receive the measurement configuration information associated with the selected beam for SSB transmission again, which will not be elaborated herein.

By way of comparison, for the terminal B located in a central part of the serving cell 0 (the service area 0), the beam position 2 thereof is not adjacent to any other cell. Only at the time T2, the terminal B remains in the beam position 2 and is about to move out of the current serving cell 0, and in this case, the cell adjacent to the beam position 2 where the terminal B is located is the neighboring cell 4. Therefore, at the time T0, in the system information broadcast by the base station to the beam position 2 where the terminal B is located, the cells adjacent to the beam position 2 include only the neighboring cell 4.

As an embodiment, the configuring corresponding measurement configuration information includes converting the time-domain position of SSB in the adjacent cell into a clock of the serving cell.

In this step, when the corresponding measurement configuration information is configured, the time-domain position of the SSB in the adjacent cell in the measurement configuration information may be firstly converted into the clock of the serving cell, and then configure for the terminal. In this way, the method according to the embodiment of the present disclosure is applicable to both synchronous and asynchronous adjacent cells.

By adopting the method according to the embodiments of the present disclosure, on the one hand, the SSBs used by the neighboring beam positions can be accurately indicated, thereby preventing the terminal from performing large-scale invalid SSB measurements that waste power consumption; on the other hand, the number of measurement windows in an interface (i.e., a Uu interface) between the base station and the terminal can also be reduced, thus avoiding the increase in the number of SMTCs. For example, as illustrated in FIG. 1, the number of neighboring beam positions around the serving cell is 12, i.e., there are 12 beam positions of other cells that have an overlapping or coverage relationship with the edge beam positions of the serving cell. Assuming that every two neighboring beam positions belong to one adjacent cell, the 12 neighboring beam positions are affiliated to 6 adjacent cells. The SSBs of each adjacent cell correspond to one SSB burst set, i.e., one SSB measurement window, and this would require configuring 6 SMTCs to meet the needs. However, the existing 3GPP protocol allows only a total of 4 SMTCs to be configured for SMTC1 and SMTC4. Therefore, according to the embodiments of the present disclosure, by configuring, according to the wave position, the time-domain positions of the beams for SSB transmission of the neighboring cells specific to each beam position, the expansion of the number of SMTCs specified in the 3GPP protocol can be avoided.

As an embodiment, the time-domain positions of the SSBs of the cells adjacent to the coverage area corresponding to the beam for SSB transmission are obtained according to the neighboring cell configuration information.

In the embodiments of the present disclosure, the base station may obtain the neighboring cell configuration information through a plurality of methods, and obtain the time-domain positions of the SSBs of the cells adjacent to the coverage area (i.e., the beam position) corresponding to the beam for SSB transmission, thereby completing the configuration of the beam for SSB transmission.

As an optional embodiment, the base station may obtain the neighboring cell configuration information generated by a ground operation and control system, wherein the ground operation and control system obtains the neighboring cell configuration information according to parameters of the adjacent cells specific to the beam for SSB transmission.

In this embodiment, the ground operation and control system plans and calculates the neighboring cell configuration information according to the adjacency relationships between the cells, the information of different beams for SSB transmission, and the adjacency relationships between the beam positions. The neighboring cell configuration information is provisioned to the base station through a management plane or in any other way, which is not limited herein.

As another optional embodiment, obtaining the time-domain positions of the SSBs of the cells adjacent to the coverage area corresponding to the beam for SSB transmission according to the neighboring cell configuration information includes:
transmitting coverage area information of cells provided by the base station between adjacent base stations through messages exchanged between base stations;
obtaining the neighboring cell configuration information according to the coverage area information of the adjacent cells.

In this embodiment, measurement configuration information Measurement Timing Configuration of the local cell may be exchanged with the neighboring cells through a field Served Cell Information NR in inter-base station Xn Application Protocol (XnAP) interface messages XN SETUP REQUEST, XN SETUP RESPONSE, NG-RAN NODE CONFIGURATION UPDATE, NG-RAN NODE CONFIGURATION UPDATE ACKNOWLEDGE, etc., and a cell SFN offset is exchanged through an SFN Offset.

As an embodiment, obtaining the time-domain positions of the SSBs of the cells adjacent to the coverage area corresponding to the beam for SSB transmission according to the neighboring cell configuration information includes:
obtaining the cells in an adjacency relationship according to the neighboring cell configuration information;
sending the time-domain positions of the SSBs of the beams for SSB transmission at the edges of the cells and geographic information of the coverage areas of the beams to the cells in an adjacency relationship.

In this embodiment, as illustrated in FIG. 5, it is a schematic diagram of the exchange of neighboring cell configuration information between base stations according to an embodiment of the present disclosure. In FIG. 5, the base station may be, for example, a satellite-borne base station. The beam position at the edge of the cell covered by the satellite-borne base station is divided into a plurality of sub-regions. Taking a cell with a simple square coverage as an example, it may be divided into four regions, i.e., an upper region, a lower region, a left region and a right region. The time-domain configurations of the SSBs deployed on the beam positions in the left region 2 (and the geographic area location information corresponding to these time-domain configurations) are sent to neighboring satellites 5 and 6 through the existing Xn interface; the time-domain configurations of the SSBs deployed in the region 3 (and the geographic area location information corresponding to these time-domain configurations) are sent to neighboring satellites 2 and 3; the time-domain configurations of the SSBs deployed in the region 4 (and the geographic area location information corresponding to these time-domain configurations) are sent to a neighboring satellite 1; and the time-domain configurations of the SSBs deployed in the region 1 (and the geographic area location information corresponding to these time-domain configurations) are sent to a neighboring satellite 4. In which, in this embodiment, the time-domain configurations of the SSBs in the overlapping area of the region 2 and the region 4 may be regarded as part of the time-domain configurations of the SSBs deployed in the region 2, or as part of the time-domain configurations of the SSBs deployed in the region 4, which is not limited by the embodiments of the present disclosure.

By adopting the method according to the embodiments of the present disclosure, it is unnecessary to uniformly configure the time-domain positions of all the SSB used by the satellite-borne base station for all neighboring satellites. Instead, the time-domain positions of the SSBs of the beams used at the edge of the coverage area of the satellite-borne base station are selectively sent to the neighboring satellites adjacent to the edge area of the local satellite, so as to prevent the satellite-borne base station from configuring invalid measurement windows for the satellite terminal. The relative positional relationship between the edge area of the local satellite and the neighboring satellite may be obtained from the ephemeris information of the local satellite and the neighboring satellite. For the constellation with a relatively stable neighboring satellite positional relationship, the above relative positional relationship may also be obtained by means of pre-configuration, which is not specifically limited by the embodiments of the present disclosure.

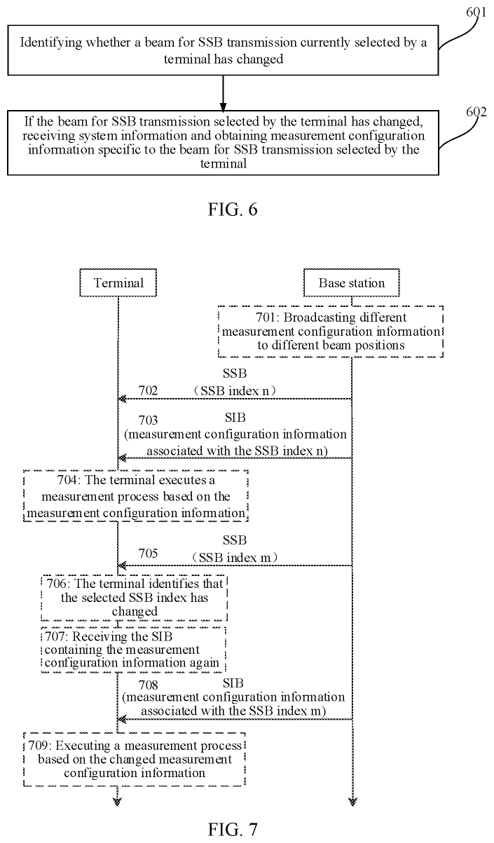

As illustrated in FIG. 6, it is a flowchart of a communication measurement configuration method according to an embodiment of the present disclosure. The method is performed by a terminal side and specifically includes:

Step 601: identifying whether a beam for SSB transmission selected by a terminal has changed;

Step 602: if the beam for SSB transmission selected by the terminal has changed, receiving system information and obtaining measurement configuration information specific to the beam for SSB transmission selected by the terminal.

By adopting the measurement configuration method according to the embodiment of the present disclosure, the terminal identifies whether the selected beam has changed according to the information of the beam selected from the SSB (e.g., the SSB index) and the information of the beam currently providing service. If the selected beam for SSB transmission has changed, the terminal measures the time-domain positions of the SSBs of the beams for SSB transmission in the cells adjacent to the coverage area (i.e., the beam position) of the currently selected beam for SSB transmission in accordance with the measurement configuration information of the beam for SSB transmission selected by the terminal, which avoids the terminal measuring the time-domain positions of the SSBs of the beams for SSB transmission (i.e., the beam positions) in all adjacent cells around the its current cell, thereby saving the power consumption of the terminal.

As an embodiment, the measurement configuration information includes: time-domain positions of SSBs of cells adjacent to the coverage area corresponding to the beam for SSB transmission selected by the terminal; and time-domain positions of SSBs of a serving cell to which the coverage area corresponding to the beam for SSB transmission selected by the terminal belongs.

In this embodiment, when the terminal is within the coverage area (i.e., the beam position) corresponding to the original beam for SSB transmission, but the beam for SSB transmission selected by the terminal corresponding to the coverage area (i.e., the beam position) changes, the received measurement configuration information includes the time-domain positions of the SSBs of the cells adjacent to the beam position corresponding to the beam selected by the terminal, and the time-domain positions of the SSBs of the serving cell where the beam position corresponding to the beam selected by the terminal is located.

As an embodiment, the method further includes: performing measurement according to the time-domain positions of the SSBs of the cells adjacent to the coverage area corresponding to the beam for SSB transmission selected by the terminal, and the time-domain positions of the SSBs of the serving cell to which the coverage area corresponding to the beam for SSB transmission selected by the terminal belongs.

In this embodiment, the terminal performs measurement on the beam positions in the serving cell where the terminal is located and the beam positions in the cells adjacent to the serving cell after the change of the beam for SSB transmission, according to the measurement configuration information obtained after the change of the beam for SSB transmission. Therefore, the terminal can perform real-time and small-range measurement on the constantly changing neighboring cells according to the movement of the satellite-borne base station to achieve the purpose of saving the power consumption.

As an embodiment, the measurement configuration information includes: the time-domain positions of the SSBs in all coverage areas corresponding to the beams for SSB transmission in the cells adjacent to the coverage area corresponding to the beam for SSB transmission selected by the terminal; and the time-domain positions of the SSBs of all coverage areas corresponding to the beams for SSB transmission in the serving cell to which the coverage area corresponding to the beam for SSB transmission selected by the terminal belongs.

In this embodiment, the measurement configuration information may include the time-domain positions of the SSBs of all the beam positions in the cells adjacent to the beam position corresponding to the beam for SSB transmission selected by the terminal. As illustrated in FIG. 3a, the measurement configuration information may include: the time-domain positions of the SSBs of all the beam positions (7 hexagons) in the adjacent cell 2 (neighboring cell 2) of the beam position A and the time-domain positions of the SSBs of all the beam positions (7 hexagons) in the adjacent cell 3 (neighboring cell 3); and the time-domain positions of the SSBs of all the beam positions in the serving cell where the beam position corresponding to the beam for SSB transmission selected by the terminal is located. In which, the adjacent cells refer to the cells having an adjacency relationship or an overlapping coverage relationship with the coverage area corresponding to the beam for SSB transmission selected by the terminal. By measuring according to the measurement configuration information, the terminal can avoid the measurement on the time-domain positions of the SSBs of all the beam positions in all the adjacent cells around the serving cell where the terminal is located in the prior art, and can also achieve the purpose of saving the power consumption of the terminal.

As an embodiment, the cells adjacent to the coverage area corresponding to the beam for SSB transmission selected by the terminal include: all cells adjacent to the coverage area corresponding to the beam for SSB transmission selected by the terminal during the satellite overpass period of the serving cell.

In this embodiment, when determining the cells adjacent to the coverage area (i.e., the beam position) corresponding to the beam for SSB transmission selected by the terminal, all cells adjacent to the beam position during the satellite overpass period need to be taken into account.

As an embodiment, the measurement configuration information includes: the time-domain positions of the SSBs of the coverage areas corresponding to other beams for SSB transmission that are adjacent to the coverage area corresponding to the beam for SSB transmission selected by the terminal in the adjacent cells; and the time-domain positions of the SSBs of the coverage areas corresponding to the beams for SSB transmission that are adjacent to the coverage area corresponding to the beam for SSB transmission selected by the terminal in the serving cell.

In this embodiment, corresponding to the above embodiment, the measurement configuration information includes the time-domain positions of the SSBs of other beam positions adjacent to the coverage area of the changed beam position, including the time-domain positions of the SSBs of the adjacent beam positions in the cells adjacent to the changed beam position, such as the time-domain positions of the neighboring beam position 1, the neighboring beam position 2 and the neighboring beam position 3 in the adjacent cell 2 (neighboring cell 2) and the adjacent cell 2 (neighboring cell 3) of the beam position A as illustrated in FIG. 3a, i.e., the SSB index 3, the SSB index 4 and the SSB index 4. The measurement configuration information further includes the time-domain positions of the SSBs of the neighboring beam positions in the serving cell to which the beam position corresponding to the beam for SSB transmission after change belongs, such as the time-domain positions of the neighboring beam position 4, the neighboring beam position 5 and the neighboring beam position 6 in the serving cell (local cell) to which the beam position A belongs as illustrated in FIG. 3a, i.e., the SSB index 2, the SSB index 3 and the SSB index 6.

As an embodiment, identifying whether the beam for SSB transmission has changed includes: identifying whether the beam for SSB transmission has changed according to the SSB index of the beam for SSB transmission selected by the terminal.

In this embodiment, the terminal may determine whether the beam has changed according to the SSB index of the beam position where the terminal is located. When the SSB index changes, it is deemed that the beam for SSB transmission has changed, and the terminal proceeds to the step of receiving the measurement configuration information configured specifically for the beam for SSB transmission selected by the terminal.

In other embodiments, the terminal may further receive pre-configured configuration information of the coverage area of the cell provided by the satellite-borne base station and all coverage areas of the beam positions within the cell. The terminal determines the coverage area of the beam position, to which the current location belongs, according to positioning information, thereby determining whether the beam position has changed.

As illustrated in FIG. 7, it is a schematic diagram of an overall measurement configuration process according to an embodiment of the present disclosure. FIG. 7 depicts the working steps of the measurement configuration process between a base station and a terminal, which specifically include:

Step 701: when broadcasting a measurement configuration by a system information block (SIB), the base station associates measurement configuration information with a beam position (i.e., the coverage area of a beam for SSB transmission), i.e., the base station broadcasts different measurement configuration information to different beam positions.

Step 702: the terminal selects an SSB with an SSB index of n during synchronization.

Step 703: the terminal receives the SIB according to a monitoring occasion associated with the SSB index n, and obtains the measurement configuration information of the beam position associated with the SSB index n (i.e., obtains the measurement configuration information associated with the beam for SSB transmission corresponding to the beam position).

Step 704: the terminal executes a measurement process according to the measurement configuration information.

Step 705: due to reasons such as terminal movement or satellite movement, an optimal SSB detected by the terminal changes, and the terminal selects another SSB with an SSB index of m.

Step 706: the terminal identifies that the selected SSB index has changed.

Step 707: the terminal receives the SIB containing the measurement configuration information again.

Step 708: the terminal receives the SIB according to the monitoring occasion associated with the SSB index m, and obtains measurement configuration information of the beam position associated with the SSB index m.

Step 709: the terminal executes a measurement process according to the measurement configuration information.

Although the process flows described above include a plurality of operations performed in a specific order, it shall be clearly understood that these processes may include more or fewer operations, and these operations may be performed sequentially or in parallel (e.g., using a parallel processor or in a multi-threaded environment).

Corresponding to the communication measurement configuration method on the base station side, the embodiments of the present disclosure further provide a base station, including: at least one processor; and at least one memory storing instructions thereon, wherein when executed individually or collectively by the at least one processor, the instructions cause the base station to perform the measurement configuration method on the above base station side.

Corresponding to the communication measurement configuration method on the terminal side, the embodiments of the present disclosure further provide a terminal, including: at least one processor; and at least one memory storing instructions thereon, wherein when executed individually or collectively by the at least one processor, the instructions cause the terminal to perform the measurement configuration method on the above terminal side.

For the convenience of description, the above devices are respectively described by being divided into various units in terms of function. Of course, during implementation of the present disclosure, the functions of various units may be realized in one or more software and/or hardware.

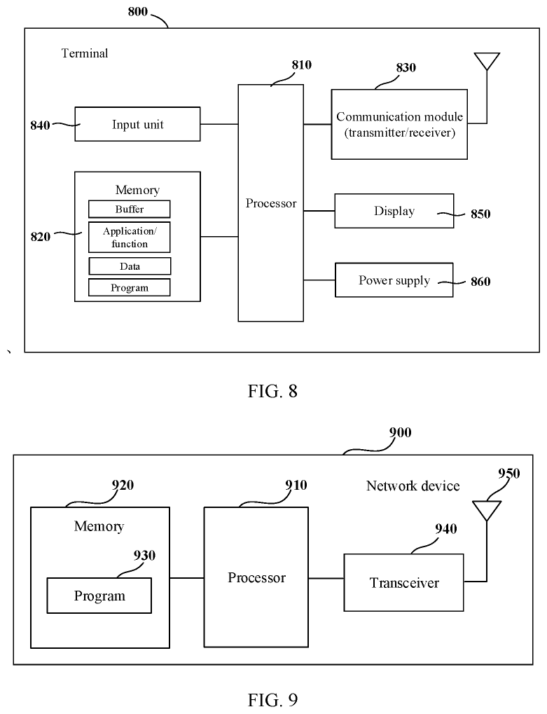

As illustrated in FIG. 8, it is a schematic diagram of a terminal according to an embodiment of the present disclosure. As illustrated in FIG. 8, the terminal 800 may include a processor 810 and a memory 820; the memory 820 stores data and a program and is coupled to the processor 810. To be noted, this diagram is exemplary, and other types of structures may also be adopted to supplement or replace this structure to realize telecommunication functions or other functions.

For example, the processor 810 may be configured to execute the program to implement the measurement configuration method on the terminal side according to the previous embodiments. For instance, the processor 810 may be configured to perform the following controls: identifying whether a beam for SSB transmission selected by a terminal has changed; and if the beam for SSB transmission selected by the terminal has changed, receiving system information and obtaining measurement configuration information specific to the beam for SSB transmission selected by the terminal.

As illustrated in FIG. 8, the terminal 800 may further include: a communication module 830, an input unit 840, a display 850, and a power supply 860. In which, the functions of the above components are similar to those in the prior art and will not be repeated herein. To be noted, the terminal 800 does not necessarily include all the components illustrated in FIG. 8, and the above components are not mandatory. In addition, the terminal 800 may further include components not illustrated in FIG. 8, which may refer to the prior art.

The embodiments of the present disclosure further provide a network device, which may be a base station, for example, but the present disclosure is not limited thereto, and it may also be other network devices.

As illustrated in FIG. 9, it is a schematic diagram of the architecture of a network device according to an embodiment of the present disclosure. As illustrated in FIG. 9, the network device 900 may include: a processor 910 (e.g., a central processing unit (CPU)) and a memory 920; the memory 920 is coupled to the processor 910, wherein the memory 920 may store various data, also store a program 930 for information processing, and the program 930 is executed under the control of the processor 910.

For example, the processor 910 may be configured to execute the program to implement the measurement configuration method on the base station side according to the previous embodiments. For instance, the processor 910 may be configured to perform the following controls: configuring corresponding measurement configuration information specific to a beam for SSB transmission; and broadcasting the configured measurement configuration information to a coverage area corresponding to the beam for SSB transmission.

In addition, as illustrated in FIG. 9, the network device 900 may further include: a transceiver 940, an antenna 950, etc., wherein the functions of the above components are similar to those in the prior art and will not be repeated herein. To be noted, the network device 900 does not necessarily include all the components illustrated in FIG. 9. Moreover, the network device 900 may also include components not illustrated in FIG. 9, which may refer to the prior art.

The present disclosure is described with reference to a flowchart and/or a block diagram of the method, the device (system), the computer-readable storage medium and the computer program product according to some embodiments of the present disclosure. It shall be appreciated that each flow and/or block in the flowchart and/or the block diagram and a combination of flows and/or blocks in the flowchart and/or the block diagram can be realized by computer program instructions. Those computer program instructions can be provided to a general computer, a dedicated computer, an embedded processor or a processor of other programmable data processing device to produce a machine, so that the instructions executed by the processor of the computer or other programmable data processing device produce means for realizing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory produce manufacture articles including an instructing device which realizes function(s) specified in one or more flows in the flowchart and/or one or more blocks in the block diagram.

These computer program instructions may also be loaded onto the computer or other programmable data processing devices, so that a series of operation steps are performed on the computer or other programmable devices to produce a processing realized by the computer, thus the instructions executed on the computer or other programmable devices provide step(s) for realizing function(s) specified in one or more flows in the flowchart and/or one or more blocks in the block diagram.

In a typical configuration, the computing device includes one or more processors (CPUs), an input/output interface, a network interface and a memory.

The memory may have the form of a volatile memory, a Random-Access Memory (RAM) and/or a nonvolatile memory such as Read-Only Memory (ROM) or a flash RAM, etc. among the computer readable medium. The memory is an example of the computer readable medium.

The computer-readable medium includes permanent and non-permanent, removable and non-removable media, which can realize the information storage in any method or technique. The information can be computer readable instructions, data structures, program modules or other data. An example of the computer storage medium includes, but not limited to, a Phase-Change Random-access Memory (PRAM), a static random access memory (SRAM), a dynamic random access memory (DRAM), other types of random access memory (RAM), a read-only memory (ROM), an electrically-erasable programmable read-only memory (EEPROM), a flash memory or other memory techniques, a compact disk read only memory (CD-ROM), a digital versatile disc (DVD) or other optical storages, magnetic cassette tapes, magnetic diskette storage or other magnetic storage device or any other non-transmission medium, which can be used for the storage of information accessible to a computing device. According to the definitions herein, the computer readable medium does not include transitory media, such as modulated data signal and carrier wave.

Those skilled in the art shall appreciate that the embodiments of the present disclosure can be provided as methods, systems or computer program products. Therefore, the present disclosure can take the form of a full hardware embodiment, a full software embodiment, or an embodiment combining software and hardware. Moreover, the embodiments of the present disclosure can take the form of a computer program product implemented on one or more computer usable storage mediums (including, but not limited to, a magnetic disc memory, CD-ROM, optical storage, etc.) containing therein computer usable program codes.

The embodiments of the present disclosure may be described in the general context of computer executable instructions executed by the computer, e.g., the program module. In general, the program module includes routine, program, object, component, data structure, etc. executing a particular task or realizing a particular abstract data type. The embodiments of the present disclosure may also be put into practice in the distributed computing environments where tasks are executed by remote processing devices connected through a communication network. In the distributed computing environments, the program modules may be located in the local and remote computer storage medium including the storage device.

It shall also be understood that in the embodiments of the present disclosure, the term “and/or” is only an association relationship that describes the associated objects, indicating that there may be three relationships. For example, A and/or B may mean that A exists alone, A and B both exist, and B exists alone. In addition, the character “/” in the present disclosure generally indicates that the contextually associated objects are in an “or” relationship.

The various embodiments of the present disclosure are all described in a progressive manner, and the same or similar portions of the various embodiments can refer to each other. Each embodiment lays an emphasis on its distinctions from other embodiments. In particular, the system embodiment is simply described since it is substantially similar to the method embodiment, and please refer to the descriptions of the method embodiment for the relevant portions.

In the description of the present disclosure, the description of reference terms “one embodiment”, “some embodiments”, “an example”, “a specific example” or “some examples” and the like mean that the specific features, structures, materials, or characteristics described in conjunction with the embodiment(s) or example(s) are included in at least one embodiment or example of the present disclosure. In the present disclosure, the schematic expressions of the above terms do not necessarily aim at the same embodiment or example. Moreover, the described specific features, structures, materials, or characteristics may be combined in any one or more embodiments or examples in a suitable manner. In addition, those skilled in the art can combine and integrate different embodiments or examples described in the present disclosure and features thereof if there is no contradiction to each other.

Those described above are merely embodiments of the present disclosure and are not intended to limit the present disclosure. For those skilled in the art, the present disclosure may have various modifications or variations. Any amendment, equivalent substitution, improvement, etc. made under the spirit and principle of the present disclosure shall fall within the scope of the claims of the present disclosure.

What is claimed is:

1. A communication method performed by a base station, the method comprising:
configuring corresponding measurement configuration information specific to a beam for synchronization signal and physical broadcast channel block (SSB) transmission;
broadcasting the configured measurement configuration information to a coverage area corresponding to the beam for SSB transmission.

2. The method according to claim 1, wherein the measurement configuration information includes: time-domain positions of SSBs of cells adjacent to the coverage area corresponding to the beam for SSB transmission; and time-domain positions of SSBs of a serving cell to which the coverage area corresponding to the beam for SSB transmission belongs.

3. The method according to claim 2, wherein the measurement configuration information includes: time-domain positions of SSBs of all coverage areas corresponding to beams for SSB transmission, in the cells adjacent to the coverage area corresponding to the beam for SSB transmission; and time-domain positions of SSBs of all coverage areas corresponding to beams for SSB transmission, in the serving cell to which the coverage area corresponding to the beam for SSB transmission belongs.

4. The method according to claim 2, wherein the adjacent cells include cells having an adjacency relationship or an overlapping coverage relationship with the coverage area corresponding to the beam for SSB transmission.

5. The method according to claim 2, wherein the cells adjacent to the coverage area corresponding to the beam for SSB transmission include all cells adjacent to the coverage area corresponding to the beam for SSB transmission during a satellite overpass period of the serving cell.

6. The method according to claim 2, wherein the measurement configuration information includes: time-domain positions of the SSBs of the coverage areas corresponding to other beams for SSB transmission, which are adjacent to the coverage area corresponding to the beam for SSB transmission, in the adjacent cells; and time-domain positions of SSBs of coverage areas corresponding to beams for SSB transmission, which are adjacent to the coverage area corresponding to the beam for SSB transmission, in the serving cell.

7. The method according to claim 2, wherein the configuring corresponding measurement configuration information includes:
converting the time-domain positions of the SSBs in the adjacent cells into a clock of the serving cell.

8. The method according to claim 2, further including:
obtaining the time-domain positions of the SSBs of the cells adjacent to the coverage area corresponding to the beam for SSB transmission according to neighboring cell configuration information.

9. The method according to claim 8, wherein the obtaining the time-domain positions of the SSBs of the cells adjacent to the coverage area corresponding to the beam for SSB transmission according to neighboring cell configuration information includes:
obtaining neighboring cell configuration information generated by a ground operation and control system, wherein the ground operation and control system obtains the neighboring cell configuration information according to parameters of adjacent cells specific to the beam for SSB transmission.

10. The method according to claim 8, wherein the obtaining the time-domain positions of the SSBs of the cells adjacent to the coverage area corresponding to the beam for SSB transmission according to neighboring cell configuration information includes:
transmitting coverage area information of cells provided by the base station between adjacent base stations through messages exchanged between base stations;
obtaining the neighboring cell configuration information according to the coverage area information of the adjacent cells.

11. The method according to claim 10, wherein the obtaining the time-domain positions of the SSBs of the cells adjacent to the coverage area corresponding to the beam for SSB transmission according to neighboring cell configuration information includes:
obtaining cells having an adjacency relationship according to the neighboring cell configuration information;
sending time-domain positions of SSBs of beams for SSB transmission at the edge of the serving cell and geographic information of coverage areas of the beams to the cells having the adjacency relationship.

12. A communication method performed by a terminal, the method comprising:
identifying whether a beam for SSB transmission selected by a terminal has changed;
if the beam for SSB transmission selected by the terminal has changed, receiving system information and obtaining measurement configuration information specific to the beam for SSB transmission selected by the terminal.

13. The method according to claim 12, wherein the measurement configuration information includes: time-domain positions of SSBs of cells adjacent to a coverage area corresponding to the beam for SSB transmission selected by the terminal; and time-domain positions of SSBs of a serving cell to which the coverage area corresponding to the beam for SSB transmission selected by the terminal belongs.

14. The method according to claim 13, further including:
performing measurement according to the time-domain positions of the SSBs of the cells adjacent to the coverage area corresponding to the beam for SSB transmission selected by the terminal, and the time-domain positions of the SSBs of the serving cell to which the coverage area corresponding to the beam for SSB transmission selected by the terminal belongs.

15. The method according to claim 14, wherein the measurement configuration information includes: time-domain positions of SSBs of all coverage areas corresponding to beams for SSB transmission, in the cells adjacent to the coverage area corresponding to the beam for SSB transmission selected by the terminal; and time-domain positions of SSBs of all coverage areas corresponding to the beams for SSB transmission, in the serving cell to which the coverage area corresponding to the beam for SSB transmission selected by the terminal belongs.

16. The method according to claim 14, wherein the adjacent cells include cells having an adjacency relationship or an overlapping coverage relationship with the coverage area corresponding to the beam for SSB transmission selected by the terminal.

17. The method according to claim 14, wherein the cells adjacent to the coverage area corresponding to the beam for SSB transmission selected by the terminal include all cells adjacent to the coverage area corresponding to the beam for SSB transmission selected by the terminal during a satellite overpass period of the serving cell.

18. The method according to claim 13, wherein the measurement configuration information includes: time-domain positions of SSBs of coverage areas corresponding to other beams for SSB transmission, which are adjacent to the coverage area corresponding to the beam for SSB transmission selected by the terminal, in the adjacent cells; and time-domain positions of SSBs of coverage areas corresponding to beams for SSB transmission, which are adjacent to the coverage area corresponding to the beam for SSB transmission selected by the terminal, in the serving cell.

19. The method according to claim 12, wherein identifying whether a beam for SSB transmission has changed includes: identifying whether the beam for SSB transmission has changed according to an SSB index of the beam for SSB transmission selected by the terminal.

20. A terminal, comprising:
at least one processor; and
at least one memory storing instructions thereon, wherein when executed individually or collectively by the at least one processor, the instructions cause the terminal to perform the method according to claim 12.
